(19) United States
(12) Patent Application Publication
(10) Pub. No.: US 2017/0075765 A1
(43) Pub. Date: Mar. 16, 2017

(54) HYBRID BACKUP AND RECOVERY MANAGEMENT SYSTEM FOR DATABASE VERSIONING AND VIRTUALIZATION WITH DATA TRANSFORMATION

(71) Applicant: ProphetStor Data Services, Inc., Taichung (TW)

(72) Inventor: Wen Shyen CHEN, Taichung (TW)

(73) Assignee: ProphetStor Data Services, Inc., Taichung (TW)

(21) Appl. No.: 14/852,864

(22) Filed: Sep. 14, 2015

(51) Int. Cl. G06F 11/14; G06F 17/30

(52) U.S. Cl. CPC G06F 11/1451; G06F 17/30371; G06F 17/30368; G06F 11/1469; G06F 2201/80; G06F 2201/805; G06F 2201/84

(57) ABSTRACT

A hybrid backup and recovery management system for database versioning and virtualization with data transformation is disclosed. The hybrid backup and recovery management system includes at least one original storage device, at least one target storage device, a database managing sub-system, and a conversion module. The present invention takes advantages of fast speed of data transmitting in volume level format while let DBAs see the procedure and interface of backup and recovery are the same as what they are used to (file level format). Current database management system can be kept just with some modules plugged in. Fast backup and recovery can be achieved.

### FIELD OF THE INVENTION

The present invention relates to a recovery management system for database versioning and virtualization. More particularly, the present invention relates to a hybrid backup and recovery management system for database versioning and virtualization with data transformation.

### BACKGROUND OF THE INVENTION

Database is the core element in all cloud services. Even in a closed environment of an enterprise or factory, dataflow and associated contents from and to all users can be important information for business owner. Thus, the database used for data collection and accesses plays the role of a decision-making assistant. Management of database is the indispensable technique in daily life.

Among all operations for management of database, backup and recovery are fundamental and the most important. Currently, there are two ways to implement. One is considered a file level operation. Take RMAN (recovery management software) of Oracle for example. When a Database Administrator (DBA) asks for backup operation, RMAN will notify a backup processing module, e.g. Oracle database manager, about this requirement. The backup processing module prepares required data from an original storage device. After reading the data from the original storage device, RMAN writes the data to a backup storage, such as a tape or disk, in file format. The processes above can be applied to both initial full backup and incremental backup. It means the DBA can see a result of backup with all desired “files” he handles via RMAN.

There are some problems in the file level backup and recovery operations. Since the backup data are files, it takes time to collect all contents of the files spread in many discrete blocks. Comparing with volume level backup, time for the file level backup is much longer, especially for initial full backup. In addition, the backup files are mainly used for restore purpose. Recovered data can only be presented in their original file (database) format. No more data transformation for other purpose, e.g. booting, training, etc., is available. Meanwhile, the DBAs are too familiar with the interface and operations of the management software, such as RMAN, it is not easy to change their operational steps and mind.

The other way to implement backup and recovery is through a volume level operation. This method is widely applied. For example, the method can be achieved by LVM (Logical Volume Manager) of IBM Corporation and BCV (Business Continuance Volume) of EMC Corporation. Take LVM for example. When a DBA asks for backup operation, the recovery management software will notify a backup processing module, e.g. Oracle database manager, about this requirement. The backup processing module synchronizes required data in an original volume managed by LVM by snapshotting to a backup volume through BCV function. The original volume and/or backup volume are managed by LVM and may include a number of disks each.

There are also many problems in the volume level backup and recovery operations. First, since volume level backup and recovery are not popular in the database management operations, DBAs are hard to adopt many new concepts from volume level backup and recovery software. Meanwhile, the DBAs are too familiar with the interface and operations of the file level management software, it is not easy to change their operational steps and mind for the one they are accustomed to. Second, like file level backup and recovery operations, the backup files are mainly used for restore purpose. Recovered data can only be presented in their original database format.

It is obvious from the above description that no matter the file level or volume level operations, the backup data are limited in use of their recovered form. It is a kind of waste of resources. The recovered data may be applied in many ways, e.g. training, recovery, development, data mining and cloud applications. Besides, if meta data can be added to the backup file(s), data transformation can be achieved. Applications of the data transformation are for booting and changing formats of database (for booting, disk ID or database ID can be simulated and added to the backup file(s) for the need of some operating systems or database systems). Preferably, the recovered data can be application aware which is different from the status before the data were backed up.

Due to the requirement above, an innovative backup and recovery management system for databases is desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to fulfill the requirements above, a hybrid backup and recovery management system for database versioning and virtualization with data transformation is disclosed. The hybrid backup and recovery management system includes: at least one original storage device, capable of processing snapshot on an original volume therein where a database is located; at least one target storage device, for building up image of the original volume; a database managing sub-system, for receiving an initial backup command and an incremental backup command, flushing current actions in the original volume according to the initial backup command or the incremental backup command, recording the time the initial backup command or the incremental backup command is received in as a time tag in a time tag area, instructing the original storage device(s) to process snapshot on the original volume, storing all snapshotted blocks in the original volume to a target volume in the at least one target storage device according to the initial backup command, storing changed files between last two snapshots to the target volume according to the incremental backup command, and recovering the database; and a conversion module, for converting the blocks in the target volume after storing of blocks in the target volume has finished into a format of a number of files which are the same as the files in the original volume when the first snapshot took place, and storing changed parts of the changed files which were changed between two snapshots to other available blocks in the target volume. A mapping table in the conversion module keeps a mapping relationship between the blocks and the corresponding converted files.

A recovery management module is connected to the original volume via the database managing sub-system, for sending the initial backup command and the incremental backup command, checking if the files being backed up in the target volume are the same as that in the original volume, and sending a recovery command to the database managing sub-system to conduct recovering of the database. The conversion module may be a software, a hardware or a firmware.

Preferably, the hybrid backup and recovery management system further includes: an application module, for changing data format of data in the target volume from one database system to another, and/or adding a new function to the target volume so that the stored data are able to provide the new function to the original volume after the database is recovered by the stored data.

Preferably, the new function is booting a host, or changing the at least one original storage device to at least one virtual machine disks. The application module may be a software, a hardware or a firmware. The original storage device may be a Hard Disk Drive (HDD), a Solid State Disk (SSD), or a hybrid disk.

A backup method using the hybrid backup and recovery management system includes the steps of: sending the initial backup command to the database managing sub-system by the recovery management module; flushing current actions in the original volume according to the initial backup command; recording the time the initial backup command is received as the time tag; processing snapshot on the original volume by the at least one original storage device instructed by the recovery management module; storing all snapshotted blocks in the original volume to the target volume in the at least one target storage device according to the initial backup command; converting the blocks in the target volume after storing of blocks in the target volume has finished into a format of a number of files by the conversion module; and checking if the files being backed up in the target volume are the same as that in the original volume by the recovery management module.

The backup method may further include the steps of: sending the incremental backup command to the database managing sub-system by the recovery management module; flushing current actions in the original volume according to the incremental backup command; recording the time the incremental backup command is received as another time tag in the time tag area; processing snapshot on the original volume by the at least one original storage device instructed by the recovery management module; storing changed parts of the changed files which were changed between two snapshots according to the incremental backup command to other available blocks in the target volume; keeping a mapping relationship between the changed part of the changed files and corresponding blocks; and checking if the files being backed up in the target volume are the same as that in the original volume by the recovery management module.

A backup method using the hybrid backup and recovery management system includes the steps of: sending the recovery command to the database managing sub-system to conduct recovering of the database by the recovery management module; assigning a recovery time from one specific time tag to be recovered; and recovering the database to the condition at the recovery time by copying files mapped to the associated files in the target volume according to the mapping table.

The present invention takes advantages of fast speed of data transmitting in volume level format while let DBAs see the procedure and interface of backup and recovery the same as what they are used to (file level format). Current database management system can be kept just with some modules plugged in. The above requirements therefore can be achieved.

### BRIEF DESCRIPTION OF THE DRAWINGS

FIG. 1 is a schematic diagram of an embodiment of a hybrid backup and recovery management system according to the present invention.

FIG. 2 shows how a mapping table works for initial backup.

FIG. 3 shows how a mapping table works for clone operation.

FIG. 4 shows how a mapping table works for incremental backup.

FIG. 5 is a flowchart of initial backup.

FIG. 6 is a flowchart of incremental backup.

FIG. 7 is a flowchart of recovery.

### DETAILED DESCRIPTION OF THE PREFERRED EMBODIMENT

The present invention will now be described more specifically with reference to the following embodiment.

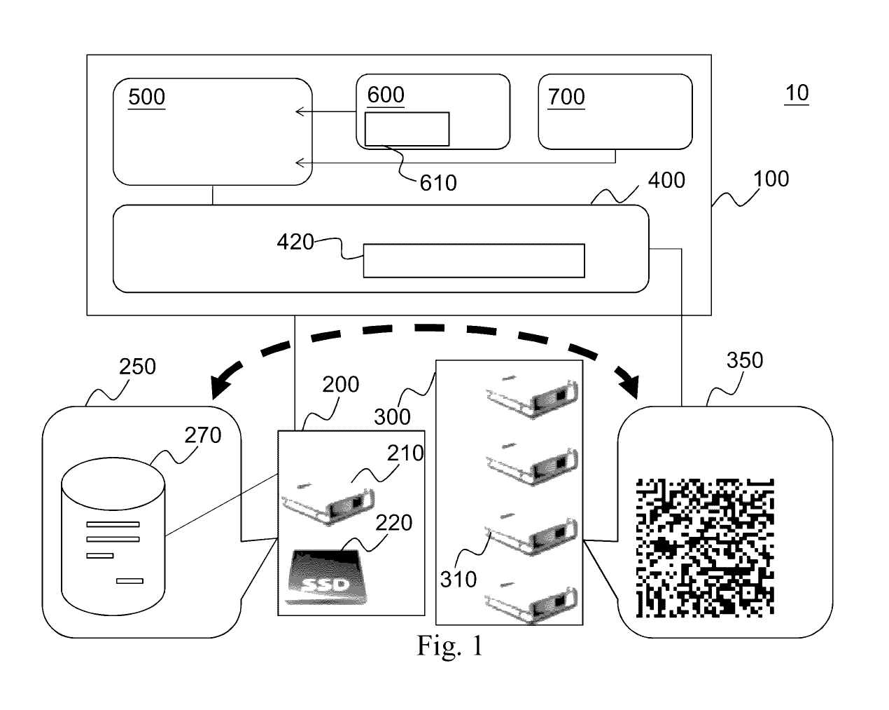

Please refer to FIG. 1. An embodiment of a hybrid backup and recovery management system 10 for database versioning and virtualization with data transformation is disclosed. The hybrid backup and recovery management system 10 includes an original storage devices cluster 200, a target storage device cluster 300, a database managing sub-system 400, a conversion module 600, and an application module 700. In fact, in order to operate the hybrid backup and recovery management system 10 smoothly, a recovery management module 500 is necessary. However, in many cases, the recovery management module 500 would be merged into the database managing sub-system 400. For a better understanding of the present invention, the recovery management module 500 is independent from the database managing sub-system 400 to be a separate unit. The database managing sub-system 400, the recovery management module 500, the conversion module 600, and the application module 700 are installed in a host 100. Each of the 4 elements mentioned may be a software installed on an operating system of the host 100 to execute specific job functions. One or all of them maybe a hardware, e.g. an add-on card to a mother board of the host 100. Or, firmware in an electrically erasable programmable read only memory can be a form of those elements. In this embodiment, the 4 elements are all in form of software. Of course, in practice, it is possible that the conversion module 600 and the application module 700 are installed in one host as two software modules while the database managing sub-system 400 and the recovery management module 500 are installed in the other host as two hardware modules. Or software modules of the recovery management module 500, the conversion module 600 and the application module 700 are installed in one host but the database managing sub-system 400 is installed in the other host. Types and installation of the 4 elements can be very flexible. It is not limited by the present invention.

The original storage device cluster 200 includes one Hard Disk Drive (HDD) 210 and one Solid State Drive (SSD) 220. The original storage device cluster 200 can provide space for storing data. According to the spirit of the present invention, only one original storage device can be used instead of the original storage device cluster 200. In this case, backup and recovery of database is only carried out single original storage device. In general, the same processes of backup and recovery can be applied to many original storage devices which may form a RAID (Redundant Array of Inexpensive Disks). The original storage device may be a HDD, a SSD, or even a hybrid disk. A feature of the original storage device cluster 200 is that it should be capable of processing snapshot on an original volume 250. A database 270 thus is formed in the original volume 250. For example, NetApp HDDs in the market can be a good choice.

The target storage device cluster 300 includes 4 HDDs 310 (named HDD 1, HDD 2, HDD 3, and HDD 4). The target storage device cluster 300 can provide space for backup data, database, or even an image file of a single disk or a cluster of disks. Similarly, only one target storage device can be used instead of the target storage device cluster 300. Namely, backup can be done in one disk as long as its capacity is large enough. Like the original storage device, the target storage device can be a HDD, a SSD, or a hybrid disk. According to the present invention, the target storage device cluster 300 is used to build up image of the original volume 250.

It should be noticed that, according to the spirit of the present invention, the original storage device cluster and the target storage device cluster can be located very close. For example, they may be parts of a RAID and data backed up or recovered are transmitted through internal connections; they may also be storages in a datacenter or for a Storage Area Network (SAN) used by an enterprise. Data backed up or recovered go transmitted through Local Area Network (LAN). The original storage device cluster and the target storage device cluster may be far away. Under this situation, the original storage device cluster and the target storage device cluster may be located in different data centers and remote backup and recovery are processed over internet or Wide Area Network (WAN).

In this example, the original volume 250 is a logical volume and the full space of the HDD 210 and the SSD 220 are used for the original volume 250. Some space in original volume 250 is left for the database 270. The rest portion of the original volume 250 may be reserved for the expansion of the database 270, storing some data unrelated to the database 270, and/or metadata of the database 270. Of course, instead of occupying the whole space of the HDD 210 and the SSD 220, the original volume 250 may also use just a portions space in the original storage device cluster 200. It is not limited by the present invention.

The database managing sub-system 400 is used to communicate with the original storage device cluster 200 and the target storage device cluster 300. Although there are some existing database systems can be used in the market as the database managing sub-system 400, such as Oracle database management solution, it must have below functions: receiving an initial backup command and an incremental backup command, flushing current actions in the database 270, recording the time as a time tag in a time tag area 420, instructing the original storage device(s) to process snapshot on the original volume 250, storing all snapshotted blocks in the original volume 250 to a target volume 350 in the at least one target storage device (the target storage device cluster 300) according to the initial backup command, storing changed files between last two snapshots to the target volume 350 according to the incremental backup command, and recovering the database 270. The time tag area 420 is a memory space in the host used by the database managing sub-system 400. It mainly records data and time of each backup. The records will be used for recovery of the database 270 back to a condition at specific time. Detailed description of the functions above will be provided later with the operations of the hybrid backup and recovery management system 10.

The recovery management module 500 is independent from the database managing sub-system 400 and focuses on the jobs of backup and recovery of databases. In the market, some solutions can be a good choice. Take Oracle RMAN as an example. A DBA can create some scripts to an interface of RMAN. Thus, backup and recovery of databases can be processed. However, RMAN processes data transmitting in file level format. It means files are copied to the destination one by one with all sections of one file is collected from related blocks. In most cases, the blocks are not sequential. Collection of data blocks wastes too much time. Although some other solutions may provide data transmitting in volume level format (direct copies of 1s and 0s in sequential blocks). However, they are not main stream and not well accepted by most of DBAs. Since the recovery management module 500 can only process file level format data transmitting, or the recovery management module 500 can carry on both file and volume level format data transmitting, however DBAs don't like to use it as it is lower level resource management tasks, distant from the application level or file level operations that DBAs are familiar with. In order to have an efficient operation, there is a requirement that keeps all procedure of the recovery management module 500 as they are for backups and recoveries in file level format while actual data transmitting is in volume or file level format depending on different conditions. This is the main spirit of the present invention and practice will be disclosed later.

The recovery management module 500 is connected to the original volume 250 via the database managing sub-system 400. It can send the initial backup command and the incremental backup command mentioned above. Furthermore, the recovery management module 500 checks if the files being backed up in the target volume 350 are the same as those files in the original volume 250. For recovery operation, the recovery management module 500 sends a recovery command to the database managing sub-system 400 to conduct recovering of the original volume 250.

The conversion module 600 is linked to the recovery management module 500. Preferably, the conversion module 600 is plugged into the recovery management module 500. The conversion module 600 is used to convert the blocks in the target volume 350 after storing of blocks in the target volume 350 has finished into a format of a number of files. The converted files are the same as the files in the original volume 250 when the first snapshot took place. If this is not done, although there is an image file in the target volume 350, for the recovery management module 500, the image file looks like a messy group of 0 and 1 as shown in FIG. 1. This is because the format is still volume level if the conversion is not done. In addition, the conversion module 600 can store changed parts of the changed files which were changed between two snapshots to other available blocks in the target volume 350, rather than re-creating a new space for the whole changed files. This is for incremental backups only. This is a feature of the present invention that block level copy is applied for initial backup to save time while file level copy is applied to incremental backups to maintain the way the DBAs are familiar with. It should be noticed that after the initial backup is finished, the conversion module 600 must inform the recovery management module 500 that the initial backup has been done to the destination with the format (file level) the recovery management module 500 recognizes. Although the initial backup was carried, it is not actually processed as the recovery management module 500 desires. This can be done by scripting the recovery management module 500.

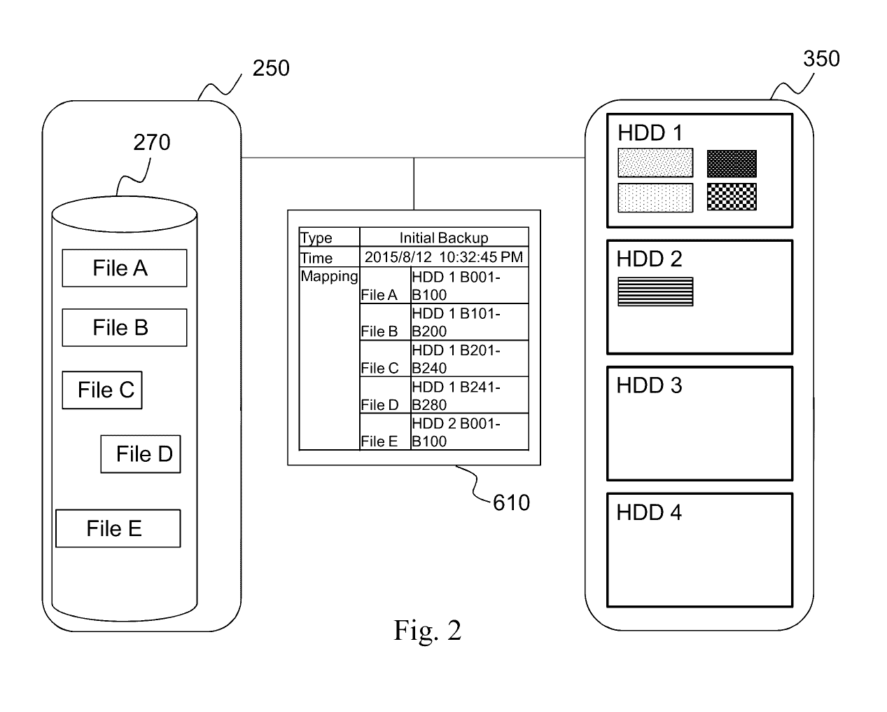

The conversion module 600 has a mapping table 610. The mapping table 610 keeps a mapping relationship between the blocks and the corresponding converted files or between the changed files and corresponding blocks (blocks of un-changed part and blocks of changed part). Please see FIG. 2. It shows how the mapping table 610 works. There are 5 files, file A, file B, file C, file D, and file E, in the database 270. After an initial backup, file A is stored in block 001 to block 100 in the HDD 1, file B is stored in block 101 to block 200 in the HDD 1, file C is stored in block 201 to block 240 in the HDD 1, file D is stored in block 241 to block 280 in the HDD 1, and file E is stored in block 001 to block 100 in the HDD 2. The above information, the time of initial backup, and type of backup (initial or incremental) will be kept in the mapping table 610. When the recovery management module 500 checks if the files of the original volume 250 have being backed up in the target volume 350, it will see the data in the mapping table 610, rather than a huge number of unknown 1s and 0s. How mapping table 610 runs under incremental backups will be introduced later.

The application module 700 provides more functions to the database 270 or the original volume 250 after recovery operation of the database 270. The application module 700 can change data format of data in the target volume 350 from one database system to another (i.e. data transformation), for example, from Oracle database to SQL database. Preferably, for data transformation, a method provided in the file patent application, numbered 14/547,305 and titled as “method and system for data transformation for cloud-based archiving and backup” can be used by the application module 700. Therefore, after the data in the target volume 350 are used to recover the database 270 in the original volume 250, the recovered database 270 may have the same contents before one backup but can only be accessed by another database system. In addition, the application module 700 may add a new function to the target volume 350 so that the stored data are able to provide the new function to the original volume 250 after the database 270 is recovered by the stored data. The new function may be a bootable volume for another host or changing the original storage device(s) to be at least one virtual machine disks. Adding new functions may be done by adding metadata, related information and/or APIs (Application Programming Interface) of the new functions to the target volume 350. There are many methods that can be used and it is not limited by the present invention. For example, booting information for one host may be added to the target volume 350. The original volume 250 can act as a booting volume after recovery of the database 270. Data in the target volume 350 may also be masked for use by applications which are not supposed to learn some information that might be confidential. A downsized database can be recovered to the original volume 250. The new database can be used for training for an enterprise or data analytics. Some applications might require a database ID or disk ID in the data in the target volume 350 to be changed. The stored data can be restored to other storages or volumes while the database management system therein deems the restored database as the one it accepts.

Backup processes of the hybrid backup and recovery management system 10 will be described below. For backups, there are three types: initial backup, incremental backup, and clone. The initial backup is an overall copy of the original volume 250 and the incremental backup just keeps changed files between the initial backup and the coming incremental backup or between two consequent incremental backups. In this case, each version of backup can be recovered with a specific versioning. However, the clone is just to copy the whole original volume 250 every time backup is carried out. Thus, the target volume 350 will only have one version of image file of the original volume 250 that it was backed up. For the present invention, backup and recovery can be versioning or non-versioning.

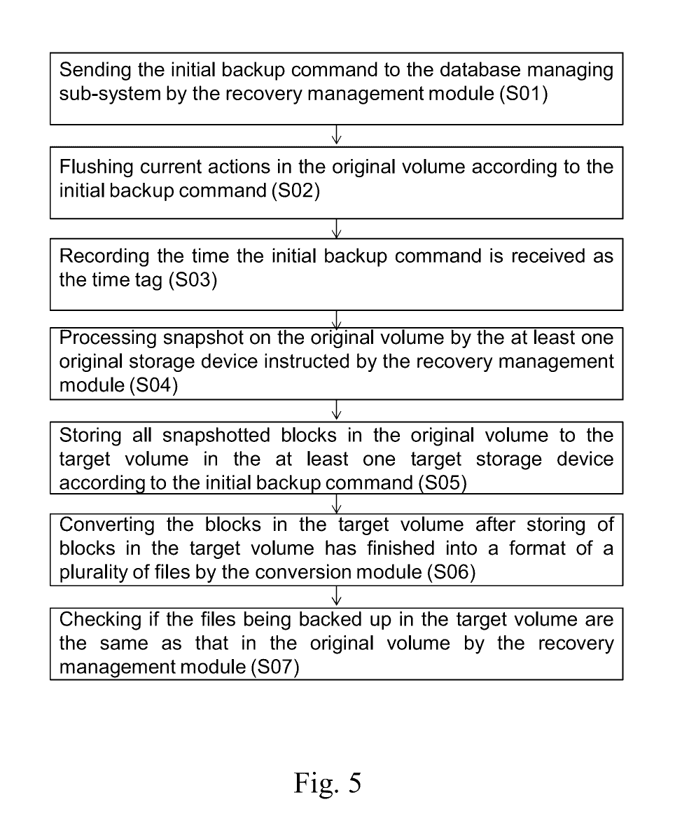

Please see FIG. 5. It is a flowchart of initial backup (for both versioning backup and clone (first clone)). The first step is to send the initial backup command to the database managing sub-system 400 by the recovery management module 500 (S01). Then, the database managing sub-system 400 starts to flush current actions in the original volume 250 according to the initial backup command (S02). Flushing means to freeze the original volume 250. Status of the original volume 250 becomes read only but no write. All actions and changes after the point of flushing will be stored to other files until backup is finished. Then, record the time the initial backup command is received as the time tag in the time tag area 420 (S03). Afterwards, snapshot on the original volume 250 is processed by the original storage device(s), which is instructed by the recovery management module 500 (S04). Now, the original storage device(s) (original storage devices cluster 200) stores all snapshotted blocks in the original volume 250 to the target volume 350 in the target storage device (s) (target storage devices cluster 300) according to the initial backup command (S05) shown by the dashed arrow in FIG. 1. The conversion module 600 converts the blocks in the target volume 350 after storing of blocks in the target volume 350 has finished into a format of a number of files (S06). The converted files are the same as those in the original volume 250 before snapshot. Last, check if the files being backed up in the target volume 350 are the same as that in the original volume 250 by the recovery management module 500 (S07). If correct, the DBA will think the backup is carried out in file level format but faster.

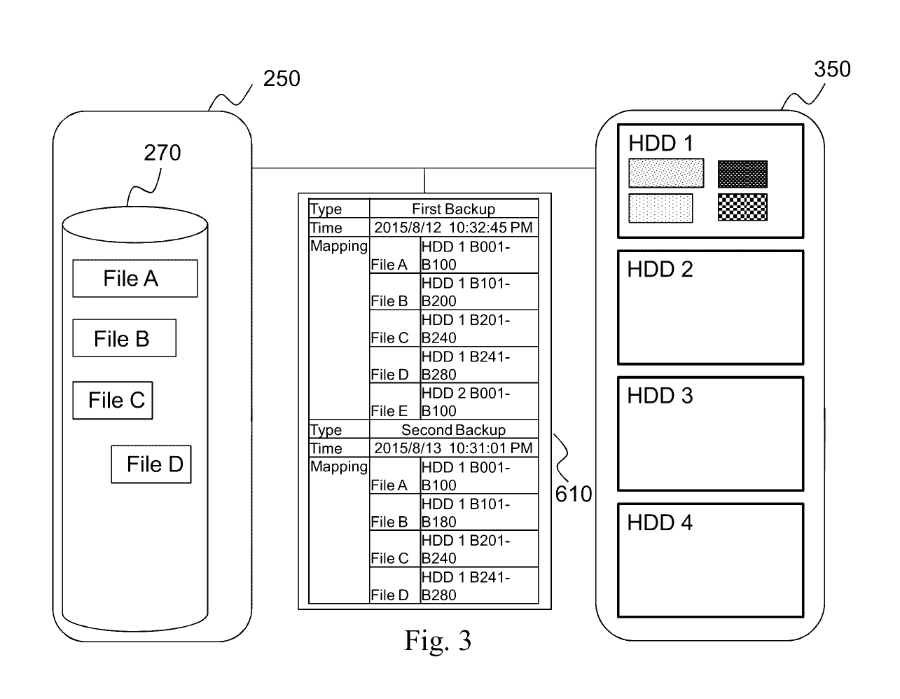

For clone operation of the original volume 250, procedures are the same as above but repeat again and again. For example, please see FIG. 3. When the second clone kicks off, two files have been changed. File B was modified and is stored in block 101 to block 180 in the HDD 1. File E was deleted. It is clear that the target volume 350 shown in FIG. 3 is changed and blocks mapping to changed files are all changed. The mapping table 610 records all blocks mapping to the new files.

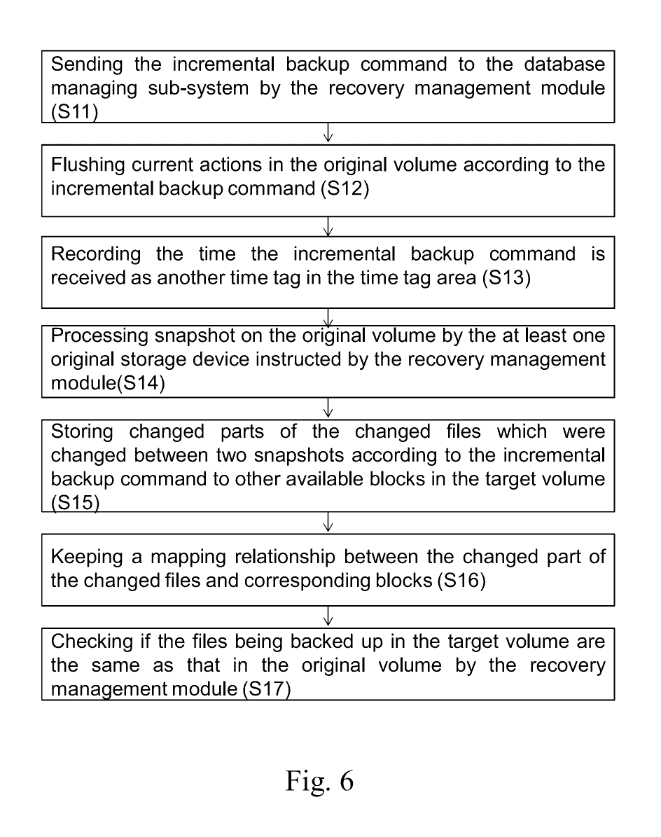

Please see FIG. 6. It is a flowchart of incremental backup operation. First, send the incremental backup command to the database managing sub-system 400 by the recovery management module 500 (S11). Then, the database managing sub-system 400 flushes current actions in the original volume 250 according to the incremental backup command (S12). Next, record the time the incremental backup command is received as another time tag in the time tag area 420 (S13). Then, process snapshot on the original volume 250 by the original storage device(s) instructed by the recovery management module 500 (S14). Now, the original storage device(s) (original storage devices cluster 200) stores changed parts of the changed files which were changed between two snapshots according to the incremental backup command to other available blocks in the target volume 350 (S15). It is not block level operation as the initial backup does anymore. The conversion module 600 keeps a mapping relationship between the changed part of the changed files and corresponding blocks (blocks of original file and blocks of the changed part) (S16). By mapping the blocks of original file and blocks of the changed part, complete changed files are available. Finally, the recovery management module 500 checks if the files being backed up in the target volume 350 are the same as that in the original volume 250 (S17). Another incremental backup operation can be processed by repeating the above steps.

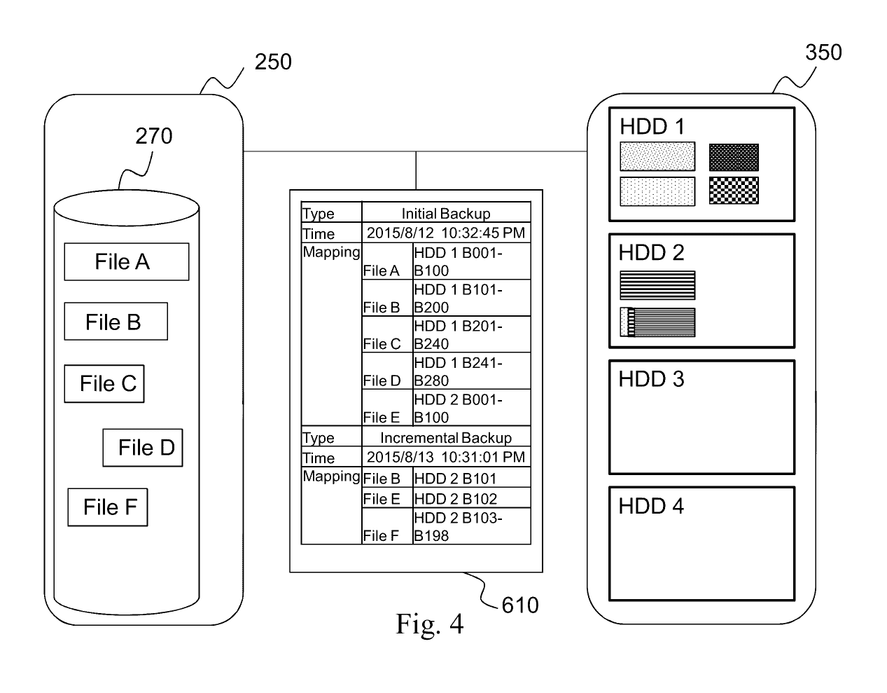

Please see FIG. 4. It shows changes in the mapping table 610 and the target volume 350. Between the initial backup and the first incremental, there are three files changed (or added). File B was modified, file E was deleted, and file F was added to the database and is stored in block 103 to block 198 in the HDD 2. Size of file B becomes shorter. From the block level format point of view, changed portion of file B is the bits in the last 20 blocks are deleted. The data needed to be kept is to describe the area of “gone” file content. Thus, this data is stored in block 101 in the HDD 2. Conversely, if file B is enlarged, the changed part will be stored in some blocks. Similarly, the deleted file E is recorded in block 102 in the HDD 2. It is obvious from FIG. 4 that the mapping table 610 records only blocks mapping to the changed parts of changed files. In the target volume 350, the data recording the initial backup are not changed.

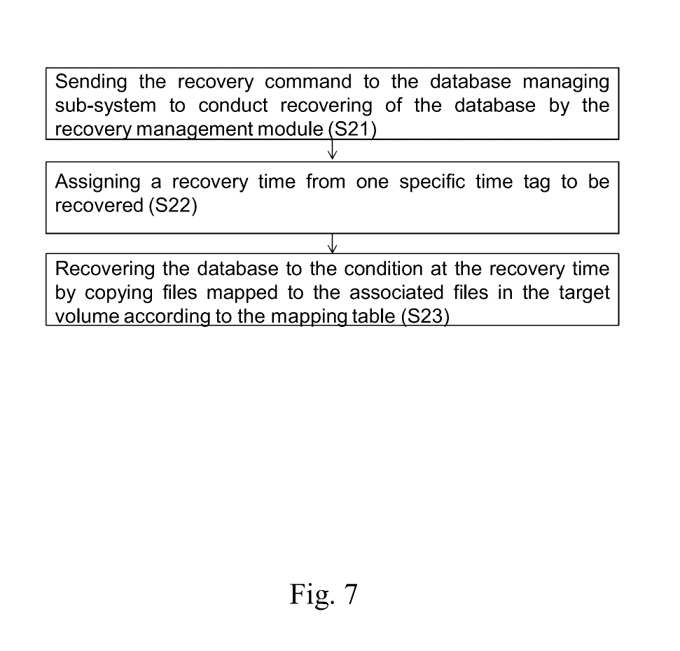

Please see FIG. 7. It is a flowchart of recovery operation. First, the recovery management module 500 sends the recovery command to the database managing sub-system 400 to conduct recovering of the database 270 (S21). Then, assigns a recovery time from one specific time tag in the time tag area 420 to be recovered (S22). Last, recover the database 270 to the condition at the recovery time by copying the blocks mapped to the associated files in the target volume 350 according to the mapping table 610 (S23).

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A hybrid backup and recovery management system for database versioning and virtualization with data transformation, comprising:
at least one original storage device, capable of processing snapshot on an original volume therein where a database is located;
at least one target storage device, for building up image of the original volume;
a database managing sub-system, for receiving an initial backup command and an incremental backup command, flushing current actions in the original volume according to the initial backup command or the incremental backup command, recording the time the initial backup command or the incremental backup command is received as a time tag in a time tag area, instructing the original storage device(s) to process snapshot on the original volume, storing all snapshotted blocks in the original volume to a target volume in according to the initial backup command, storing changed files between last two snapshots to the target volume according to the incremental backup command, and recovering the database; and
a conversion module, for converting the blocks in the target volume after storing of blocks in the target volume has finished into a format of a plurality of files which are the same as the files in the original volume when the first snapshot took place, and storing changed parts of the changed files which were changed between two snapshots to other available blocks in the target volume.
wherein a mapping table in the conversion module keeps a mapping relationship between the blocks and the corresponding converted files or between the changed files and corresponding blocks.

2. The hybrid backup and recovery management system according to claim 1, wherein a recovery management module is connected to the at least one original storage device via the database managing sub-system, for sending the initial backup command and the incremental backup command, checking if the files being backed up in the target volume are the same as that in the original volume, and sending a recovery command to the database managing sub-system to conduct recovering of the database.

3. The hybrid backup and recovery management system according to claim 1, wherein the conversion module is a software, a hardware or a firmware.

4. The hybrid backup and recovery management system according to claim 1, further comprising:
an application module, for changing data format of data in the target volume from one database system to another, and/or adding a new function to the target volume so that the stored data are able to provide the new function to the original volume after the database is recovered by the stored data.

5. The hybrid backup and recovery management system according to claim 4, wherein the new function is booting a host, or changing the at least one original storage device to at least one virtual machine disks.

6. The hybrid backup and recovery management system according to claim 4, wherein the application module is a software, a hardware or a firmware.

7. The hybrid backup and recovery management system according to claim 1, wherein the original storage device is a Hard Disk Drive (HDD), a Solid State Disk (SSD), or a hybrid disk.

8. A backup method using the hybrid backup and recovery management system according to claim 2, comprising the steps of:
A. sending the initial backup command to the database managing sub-system by the recovery management module;
B. flushing current actions in the original volume according to the initial backup command;
C. recording the time the initial backup command is received as the time tag;
D. processing snapshot on the original volume by the at least one original storage device instructed by the recovery management module;
E. storing all snapshotted blocks in the original volume to the target volume in the at least one target storage device according to the initial backup command;
F. converting the blocks in the target volume after storing of blocks in the target volume has finished into a format of a plurality of files by the conversion module; and
G. checking if the files being backed up in the target volume are the same as that in the original volume by the recovery management module.

9. The backup method according to claim 8, further comprising the steps of:
H. sending the incremental backup command to the database managing sub-system by the recovery management module;
I. flushing current actions in the original volume according to the incremental backup command;
J. recording the time the incremental backup command is received as another time tag in the time tag area;
K. processing snapshot on the original volume by the at least one original storage device instructed by the recovery management module;
L. storing changed parts of the changed files which were changed between two snapshots according to the incremental backup command to other available blocks in the target volume;
M. keeping a mapping relationship between the changed part of the changed files and corresponding blocks; and
N. checking if the files being backed up in the target volume are the same as that in the original volume by the recovery management module.

10. A backup method using the hybrid backup and recovery management system according to claim 2, comprising the steps of:
A. sending the recovery command to the database managing sub-system to conduct recovering of the database by the recovery management module;
B. assigning a recovery time from one specific time tag to be recovered; and
C. recovering the database to the condition at the recovery time by copying files mapped to the associated files in the target volume according to the mapping table.
